(19) United States
(12) Patent Application Publication
(10) Pub. No.: US 2025/0316752 A1
(43) Pub. Date: Oct. 9, 2025

(54) SOLID-STATE BATTERY

(71) Applicant: Murata Manufacturing Co., Ltd., Nagaokakyo-shi (JP)

(72) Inventors: Nobuyuki IWANE, Nagaokakyo-shi (JP); Shunya Hatsugai, Nagaokakyo-shi (JP)

(21) Appl. No.: 19/245,855

(22) Filed: Jun. 23, 2025

Related U.S. Application Data
(63) Continuation of application No. PCT/JP2023/045081, filed on Dec. 15, 2023.

(30) Foreign Application Priority Data
Jan. 13, 2023 (JP) 2023-004053

(51) Int. Cl. H01M 10/0562; H01M 4/134; H01M 10/0525

(52) U.S. Cl. CPC H01M 10/0562; H01M 4/134; H01M 10/0525

(57) ABSTRACT

A solid-state battery including: a positive electrode layer containing a positive electrode active material containing Li and a solid electrolyte, wherein a thermal weight reduction starting temperature at which a weight of the positive electrode active material decreases by 0.67% or more is 220° C. or higher and lower than 485° C. in a state where a lithium desorption amount of the positive electrode active material is 40%, and the solid electrolyte contains lithium borosilicate glass.

### CROSS REFERENCE TO RELATED APPLICATIONS

The present application is a continuation of International application No. PCT/JP2023/045081, filed Dec. 15, 2023, which claims priority to Japanese Patent Application No. 2023-004053, filed Jan. 13, 2023, the entire contents of each of which are incorporated herein by reference.

### TECHNICAL FIELD

The present disclosure relates to a solid-state battery.

### BACKGROUND ART

Conventionally, secondary batteries that can be repeatedly charged and discharged have been used for various applications. For example, secondary batteries are used as power sources of electronic devices such as smartphones and notebooks.

In a secondary battery, a liquid electrolyte is generally used as a medium for ion transfer that contributes to charge and discharge. More specifically, a so-called electrolytic solution is used for the secondary battery. However, in such a secondary battery, safety is generally required in terms of preventing leakage of the electrolytic solution. In addition, because an organic solvent and the like for use in the electrolytic solution are flammable substances, safety is required in that respect as well.

Therefore, a solid-state battery using a solid electrolyte instead of the electrolytic solution has been studied.

Patent Document 1: Japanese Patent No. 5211721

Patent Document 2: Japanese Patent Application Laid-Open No. 2021-516424

### SUMMARY OF THE DISCLOSURE

The inventors of the present application have newly found that there are points that can be improved in the conventional solid-state battery, and it is necessary to take measures therefor.

Specifically, as the positive electrode active material in the solid-state battery, a lithium transition metal oxide or a lithium composite transition metal oxide having a crystal structure can be used (see Patent Documents 1 and 2). In this regard, the solid-state battery may be used under a high temperature condition, but under such a high temperature condition, the crystal structure of the positive electrode active material becomes unstable as lithium is desorbed, and due to this, the battery characteristics of the solid-state battery under a high temperature condition may be deteriorated.

The present disclosure has been made in view of such problems. That is, an object of the present disclosure is to provide a solid-state battery capable of having more suitable battery characteristics even under a high temperature condition.

To achieve the above object, in an embodiment of the present disclosure, there is provided a solid-state battery including: a positive electrode layer containing a positive electrode active material containing Li and a solid electrolyte, wherein a thermal weight reduction starting temperature at which a weight of the positive electrode active material decreases by 0.67% or more is 220° C. or higher and lower than 485° C. in a state where a lithium desorption amount of the positive electrode active material is 40%, and the solid electrolyte contains lithium borosilicate glass.

The solid-state battery according to an embodiment of the present disclosure can have more suitable battery characteristics even under a high temperature condition.

### BRIEF EXPLANATION OF THE DRAWINGS

FIG. 1 is an external perspective view schematically illustrating a solid-state battery according to an embodiment of the present disclosure.

FIG. 2 is a schematic sectional view of the solid-state battery in FIG. 1 taken along line A-A as viewed in an arrow direction.

FIG. 3 is a graph showing a relationship between a heating temperature and a thermal weight change (reduction) rate of a positive electrode active material in a solid-state battery according to an embodiment of the present disclosure.

### DESCRIPTION OF THE PREFERRED EMBODIMENTS

Hereinafter, the solid-state battery of the present disclosure will be described in detail. Although description will be made with reference to the drawings as necessary, the shown contents are only schematically and exemplarily illustrated for the understanding of the present disclosure, and the appearance, the dimensional ratio, and the like may be different from the actual ones.

The “sectional view” as used in the present description is based on a form (briefly, a form in the case of being cut along a plane parallel to the layer thickness direction) viewed from a direction substantially perpendicular to the stacking direction in the stacked structure of the solid-state battery. In addition, the “plan view” or “plan view shape” used in the present description is based on a sketch drawing when an object is viewed from an upper side or a lower side along the layer thickness direction (that is, the stacking direction mentioned above).

The “vertical direction” and “horizontal direction” used directly or indirectly in the present description correspond to a vertical direction and a horizontal direction in the drawings, respectively. Unless otherwise specified, the same reference signs or symbols shall denote the same members or sites or the same meanings. In a preferred aspect, it can be understood that the downward direction in the vertical direction (that is, the direction in which gravity acts) corresponds to a “downward direction”, and the opposite direction corresponds to an “upward direction”.

The term “solid-state battery” used in the present disclosure refers to, in a broad sense, a battery whose constituent elements are composed of solid and refers to, in a narrow sense, an all-solid-state battery whose constituent elements (particularly preferably all constituent elements) are composed of solid. In a preferred aspect, the solid-state battery in the present disclosure is a stacked solid-state battery configured such that layers constituting a battery constituent unit are stacked on each other, and such layers are preferably made of fired bodies. The “solid-state battery” is a so-called “secondary battery” that can be repeatedly charged and discharged. The “secondary battery” is not excessively restricted by its name, which can encompass, for example, a power storage device and the like.

The feature of the present disclosure relates to a positive electrode layer included in the solid-state battery. Hereinafter, in order to grasp the overall structure of the solid-state battery, the basic configuration of the solid-state battery according to the present disclosure will be first described. However, the configuration of the solid-state battery described here is merely an example for understanding the disclosure, and not considered limiting the disclosure.

### Basic Configuration of Solid-State Battery

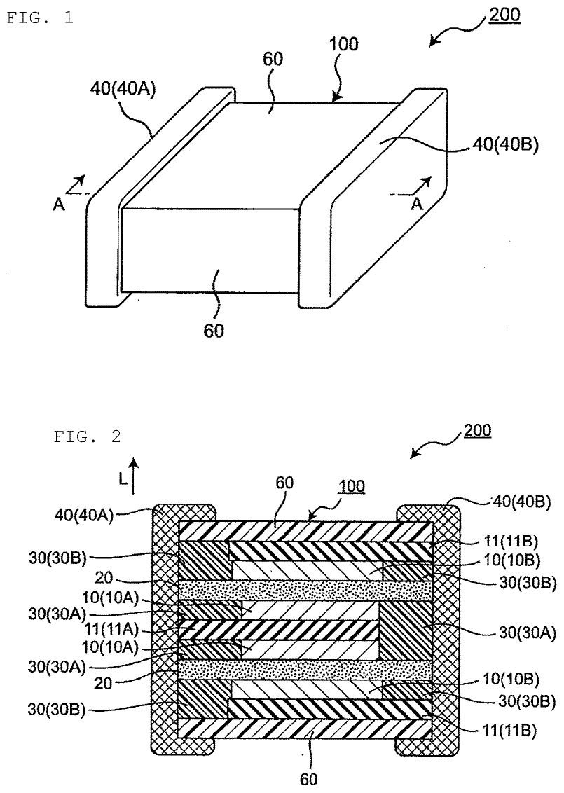

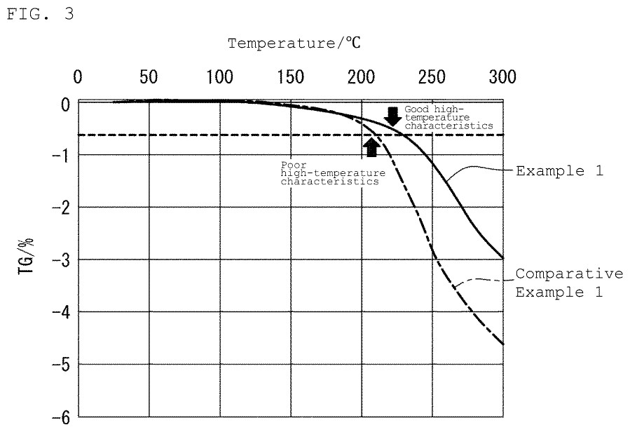

FIG. 1 is an external perspective view schematically showing a solid-state battery according to an embodiment of the present disclosure. FIG. 2 is a schematic sectional view of the solid-state battery in FIG. 1 taken along line A-A as viewed in an arrow direction. The solid-state battery includes at least electrode layers: a positive electrode and a negative electrode, and a solid electrolyte. Specifically, as illustrated in FIGS. 1 and 2, a solid-state battery 200 includes a solid-state battery laminate 100 including a battery constituent unit composed of a positive electrode layer 10A, a negative electrode layer 10B, and a solid electrolyte layer 20 at least interposed between the electrode layers.

The solid-state battery 200 according to the present disclosure includes: a solid-state battery laminate 100 including at least one battery constituent unit, including the positive electrode layer 10A, the negative electrode layer 10B, and the solid electrolyte layer 20 interposed therebetween, along a stacking direction L; and a positive electrode terminal 40A and a negative electrode terminal 40B each provided on facing side surfaces of the solid-state battery laminate 100.

In the solid-state battery laminate 100, the positive electrode layer 10A and the negative electrode layer 10B are alternately stacked with the solid electrolyte layer 20 interposed therebetween.

For the solid-state battery, each layer constituting the solid-state battery may be formed by firing, and the positive electrode layer, the negative electrode layer, the solid electrolyte layer, and the like may form fired layers. Preferably, the positive electrode layer, the negative electrode layer, and the solid electrolyte layer are each fired integrally with each other, and the solid-state battery laminate preferably forms an integrally fired body.

The positive electrode layer is an electrode layer including at least a positive electrode active material. The positive electrode layer may further contain a solid electrolyte. In a preferred aspect, the positive electrode layer is formed of a fired body including at least positive electrode active material particles and solid electrolyte particles. In contrast, the negative electrode layer is an electrode layer containing at least a negative electrode active material. The negative electrode layer may further contain a solid electrolyte. In a preferred aspect, the negative electrode layer is formed of a sintered body including at least negative electrode active material particles and solid electrolyte particles. The positive electrode layer having such a configuration is referred to as a “composite positive electrode body”, and similarly, the negative electrode layer may be referred to as a “composite negative electrode body”.

The positive electrode active material and the negative electrode active material are substances involved in the transfer of electrons in the solid-state battery. Ions move (conduct) between the positive electrode layer and the negative electrode layer through the solid electrolyte to transfer electrons, thereby charging and discharging the battery. Each electrode layer of the positive electrode layer and the negative electrode layer is preferably a layer capable of occluding and releasing lithium ions or sodium ions, in particular. More particularly, the solid-state battery is preferably an all-solid-state secondary battery in which lithium ions or sodium ions move between the positive electrode layer and the negative electrode layer through the solid electrolyte, thereby charging and discharging the battery.

### (Positive Electrode Layer)

The content of the solid electrolyte in the positive electrode layer 10A is not particularly limited, and is usually 10 to 50 mass %, and particularly preferably 20 to 40mass % with respect to the total amount of the positive electrode layer. The positive electrode layer may contain two or more types of solid electrolytes, and in that case, the total content thereof may be within the above range.

### (Negative Electrode Layer)

Examples of the negative electrode active material included in the negative electrode layer include at least one selected from the group consisting of oxides containing at least one element selected from the group consisting of titanium (Ti), silicon (Si), tin (Sn), chromium (Cr), iron (Fe), niobium (Nb), and molybdenum (Mo), carbon materials such as graphite, graphite-lithium compounds, lithium alloys, lithium-containing phosphate compounds that have a NASICON-type structure, lithium-containing phosphate compounds that have an olivine-type structure, and lithium-containing oxides that have a spinel-type structure. Examples of the lithium alloys include Li-Al. Examples of the lithium-containing phosphate compounds that have a NASICON-type structure include Li₃V₂(PO₄)₃ and/or LiTi₂(PO₄)₃. Examples of the lithium-containing phosphate compounds that have an olivine-type structure include Li₃Fe₂(PO₄)₃ and/or LiCuPO₄. Examples of the lithium-containing oxides that have a spinel type structure include Li₄Ti₅O₁₂.

In addition, examples of negative electrode active materials capable of occluding and releasing sodium ions include at least one selected from the group consisting of sodium-containing phosphate compounds that have a NASICON-type structure, sodium-containing phosphate compounds that have an olivine-type structure, and sodium-containing oxides that have a spinel-type structure.

The positive electrode layer and/or the negative electrode layer may include a conductive material. Examples of the conductive material included in the positive electrode layer and the negative electrode layer include at least one of metal materials such as silver, palladium, gold, platinum, aluminum, copper, and nickel, and carbon.

Further, the positive electrode layer and/or the negative electrode layer may include a sintering aid. Examples of the sintering aid include at least one selected from the group consisting of a lithium oxide, a sodium oxide, a potassium oxide, a boron oxide, a silicon oxide, a bismuth oxide, and a phosphorus oxide.

The thicknesses of the positive electrode layer and negative electrode layer are not particularly limited, but may be each independently, for example, 2 μm to 50 μm, particularly 5 μm to 30 μm.

### (Positive Electrode Current Collector Layer/Negative Electrode Current Collector Layer)

Although not an essential element for the electrode layer, the positive electrode layer and the negative electrode layer may respectively include a positive electrode current collector layer 11A and a negative electrode current collector layer 11B. The positive electrode current collector layer and the negative electrode current collector layer may each have the form of a foil. The positive electrode current collector layer and the negative electrode current collector layer may each have, however, the form of a fired body, if more importance is placed on viewpoints such as improving the electron conductivity, reducing the manufacturing cost of the solid-state battery, and/or reducing the internal resistance of the solid-state battery by integral firing.

As the positive electrode current collector constituting the positive electrode current collector layer and the negative electrode current collector constituting the negative electrode current collector, it is preferable to use a material with a high conductivity, and for example, silver, palladium, gold, platinum, aluminum, copper, and/or nickel may be used. The positive electrode current collector and the negative electrode current collector may each have an electrical connection for being electrically connected to the outside, and may be configured to be electrically connectable to a terminal.

It is to be noted that when the positive electrode current collector layer and the negative electrode current collector layer have the form of a fired body, the layers may be composed of a fired body including a conductive material and a sintering aid. The conductive materials included in the positive electrode current collector layer and the negative electrode current collector layer may be selected from, for example, the same materials as the conductive materials that can be included in the positive electrode layer and the negative electrode layer. The sintering aid included in the positive electrode current collector layer and the negative electrode current collector layer may be selected from, for example, the same materials as sintering aids that can be included in the positive electrode layer/the negative electrode layer.

### (Solid Electrolyte)

The solid electrolyte is a material capable of conducting lithium ions or sodium ions. The solid electrolyte can constitute a layer through which a lithium ion can conduct between the positive electrode layer and the negative electrode layer. The solid electrolyte can also be contained in the positive electrode layer and the negative electrode layer.

The solid electrolyte layer may contain a sintering aid. The sintering aid contained in the solid electrolyte layer may be selected from, for example, the same materials as the sintering aids that can be contained in the positive electrode layer/negative electrode layer.

The thickness of the solid electrolyte layer is not particularly limited. The thickness of the solid electrolyte layer located between the positive electrode layer and the negative electrode layer may be, for example, 1 μm to 15 μm, particularly 1 μm to 5 μm.

### (Electrode Separator)

The solid-state battery 200 of the present disclosure may further include an electrode separator (also referred to as “margin layer” or “margin portion”) 30 (30A, 30B).

The electrode separator 30A (positive electrode separator) is disposed around the positive electrode layer 10A, so that the positive electrode layer 10A is spaced apart from the negative electrode terminal 40B. The electrode separator 30B (negative electrode separator) is disposed around the negative electrode layer 10B, so that the negative electrode layer 10B is spaced apart from the positive electrode terminal 40A. Although not particularly limited, the electrode separator 30 may be compose of, for example, one or more materials selected from the group consisting of a solid electrolyte, an insulating material, a mixture thereof, and the like.

As the solid electrolyte that can constitute the electrode separator 30, the same material as the solid electrolyte that can constitute the solid electrolyte layer can be used.

The insulating material that can constitute the electrode separator 30 may be a material that does not conduct electricity, that is, a non-conductive material. Although not particularly limited, the insulating material may be, for example, a glass material, a ceramic material, or the like. For example, a glass material may be selected as the insulating material. Although not particularly limited, examples of the glass material include at least one selected from the group consisting of soda lime glass, potash glass, borate glass, borosilicate glass, barium borosilicate-based glass, zinc borate glass, barium borate glass, borosilicate bismuth salt-based glass, bismuth zinc borate glass, bismuth silicate glass, phosphate glass, aluminophosphate glass, and zinc phosphate glass. The ceramic material is not particularly limited, but examples thereof include at least one selected from the group consisting of aluminum oxide (Al₂O₃), boron nitride (BN), silicon dioxide (SiO₂), silicon nitride (Si₃N₄), zirconium oxide (ZrO₂), aluminum nitride (AlN), silicon carbide (SiC), and barium titanate (BaTiO₃).

### (Terminal)

The solid-state battery 200 of the present disclosure is generally provided with a terminal (external terminal) 40 (40A, 40B). In particular, terminals 40A and 40B of the positive and negative electrodes are provided to form a pair on a side surface of the solid-state battery. More specifically, the terminal 40A on the positive electrode side connected to the positive electrode layer 10A and the terminal 40B on the negative electrode side connected to the negative electrode layer 10B are provided so as to form a pair. Since the terminals 40A and 40B may be provided so as to cover at least one side surface of the solid-state battery, they may be referred to as “end face electrodes”. As the terminal 40 (40A, 40B) as described above, it is possible to use a material having high conductivity. Although not particularly limited, examples of the material of the terminal 40 include at least one conductive material selected from the group consisting of silver, gold, platinum, aluminum, copper, tin, and nickel.

The terminal 40 (40A, 40B) may further contain a sintering aid. Examples of the sintering aid include a material similar to the sintering aid that may be contained in the positive electrode layer 10A. In a preferred embodiment, the terminal 40 (40A, 40B) is composed of a sintered body including at least the conductive material and the sintering aid.

### (Outer Layer Material)

The solid-state battery 200 of the present disclosure usually further includes an outer layer material 60. The outer layer material 60 can be generally formed on an outermost side of the solid-state battery, and used to electrically, physically, and/or chemically protect. As a material forming the outer layer material 60, preferred is a material that is excellent in insulation property, durability and/or moisture resistance, and is environmentally safe. For example, it is possible to use glass, ceramics, a thermosetting resin, a photocurable resin, a mixture thereof, and the like.

As glass that can constitute the outer layer material, the same material as the glass material that can constitute the electrode separator can be used. In addition, as a ceramic material that can constitute the outer layer material, the same material as the ceramic material that can constitute the electrode separator can be used.

### Features of Solid-State Battery of Present Disclosure

The inventors of the present application have intensively studied a solution for enabling a solid-state battery to have more suitable battery characteristics even in the case of using a solid-state battery under a high temperature condition. As a result, the inventors of the present application have focused on the positive electrode layer constituting solid-state battery, and has achieved the solution. Specifically, on the premise that a solid electrolyte having a specific material composition is contained in the positive electrode layer, the inventors of the present application have newly found that the thermal weight reduction starting temperature of the positive electrode active material containing Li (lithium) can be correlated with battery characteristics (that is, high-temperature resistance) under a high temperature condition.

FIG. 3 is a graph showing a relationship between a heating temperature and a thermal weight change (reduction) rate of a positive electrode active material in a solid-state battery according to an embodiment of the present disclosure. As shown in FIG. 3, it can be seen that as the heating temperature of the positive electrode active material is increased, the thermal weight change (reduction) rate of the positive electrode active material increases from a temperature equal to or higher than a predetermined temperature. FIG. 3 also shows two thermogravimetry (TG) curves (TG curve for Example 1 and TG curve for Comparative Example 1) in which the temperature at which the thermal weight reduction starts (that is, thermal weight reduction starting temperature) is different. As can be seen from the section of Examples described later, this thermal weight reduction starting temperature varies depending on a difference in material composition between the positive electrode active material and the solid electrolyte contained in the positive electrode layer, and this different thermal weight reduction starting temperature can be correlated with the battery characteristics under a high temperature condition.

In the present disclosure, based on these features, a positive electrode active material having a thermal weight reduction starting temperature in a specific range, particularly, a positive electrode active material having a thermal weight reduction starting temperature equal to or higher than a specific lower limit value, is suitably selected for the positive electrode layer under the condition that a solid electrolyte having a specific material composition is contained.

Specifically, in the present disclosure, as for the positive electrode layer, under the condition that lithium borosilicate glass is contained as a solid electrolyte, a positive electrode active material can be selected in which a thermal weight reduction starting temperature at which a weight decreases by 0.67% or more in a state where a lithium desorption amount of the positive electrode active material is 40% (that is, a state where 40% of the Li amount of the positive electrode active material is desorbed) is 220° C. or higher and lower than 485° C. In the present disclosure, by selecting the positive electrode layer having the above-described characteristics for the solid-state battery, more suitable battery characteristics under a high temperature condition can be achieved. That is, a solid-state battery having more excellent high-temperature resistance can be provided.

Specifically, in the solid-state battery including the positive electrode layer having the characteristics as described above, even when the solid-state battery is exposed to a high temperature (for example, a temperature range of 80° C. to 200° C.), deterioration of battery characteristics such as a resistance value and/or a battery capacity can be more suitably suppressed. Therefore, the solid-state battery of the present disclosure can be suitably used even under a high temperature condition.

In the present disclosure, the lower limit value (220° C. or higher) of the thermal weight reduction starting temperature of the positive electrode active material contributes to the maintenance of the high-temperature resistance of the solid-state battery, and the upper limit value (lower than 485° C.) is based on the viewpoint of suppressing the decrease in electron conductivity of the positive electrode active material. Note that, from the viewpoint of suitably achieving both the maintenance of the high-temperature resistance of the solid-state battery and the suppression of the decrease in electron conductivity of the positive electrode active material, the upper limit value of the thermal weight reduction starting temperature may be 350° C. or lower.

Note that the thermal weight reduction starting temperature of the positive electrode active material can be measured using a thermogravimetric/differential thermal analyzer (manufactured by Rigaku Corporation, device model number: TG8120). Specifically, a sample (a positive electrode layer or the like) is set in this device, and heating is performed under the condition of a predetermined temperature increase rate while flowing nitrogen at a predetermined rate, thereby measuring the thermal weight reduction starting temperature of the positive electrode active material at which the weight decreases by 0.67% or more. In this device, as the temperature of the sample is increased, the weight of the positive electrode active material contained in the positive electrode layer changes from a predetermined temperature value. When this weight change occurs, the main beam in the measurement device is tilted, and the current flowing through the coil is controlled so as to restore the movement. Since the flowed current corresponds to a weight change, a variation behavior of the current is output as a weight change, so that it is possible to grasp the thermal weight reduction starting temperature of the positive electrode active material.

The “state where a lithium desorption amount of the positive electrode active material is 40%” as used herein refers to a state where the lithium desorption amount is 40% when the desorption amount of lithium with respect to the lithium content of the positive electrode active material is represented as a 100%. In other words, the “state where a lithium desorption amount of the positive electrode active material is 40%” means a state where the lithium content of the positive electrode active material is 60% with the lithium content of the positive electrode active material in a battery in an uncharged state as 100%. For example, the “state where a lithium desorption amount of the positive electrode active material is 40%” may be a charged state where 40% of lithium is extracted from the amount of lithium contained in the positive electrode active material in the battery at the time of full discharge. Note that, in a state where Li in the positive electrode active material is extracted, measurement can be performed using XRD.

Note that, in the present disclosure, the reason why the thermal weight reduction starting temperature of the positive electrode active material in a state where the lithium desorption amount of the positive electrode active material contained in the positive electrode layer is 40% is evaluated, is as follows. When the solid-state battery is charged, the lithium is extracted, so that the crystal structure of the positive electrode active material may become unstable; however, this destabilization can be seen from the charged state where 40% of the Li amount of the positive electrode active material is desorbed, and can be particularly remarkable under the battery use condition at a high temperature. With such destabilization of the crystal structure, in a state where 40% of the Li amount of the positive electrode active material is desorbed under a high temperature condition, deterioration of the solid-state battery may easily proceed. From the above, the thermal weight reduction starting temperature of the positive electrode active material in a state where 40% of the Li amount of the positive electrode active material is desorbed, is evaluated.

The lithium desorption amount can be quantified by XRD analysis. Alternatively, based on the initial charge/discharge efficiency and the basis weight of the positive electrode active material and the negative electrode active material, the lithium desorption amount can also be calculated from the charge amount of the solid-state battery.

The lithium borosilicate glass contained in the positive electrode layer is an oxide-based glass material containing at least lithium (Li), silicon (Si), and boron (B) as constituent elements, and can be, for example, 50Li₄SiO₄-50Li₃BO₃. Since such a solid electrolyte has relatively high thermal stability, it is possible to more suitably suppress deterioration of battery characteristics of the solid-state battery under a high temperature condition by containing the solid electrolyte in the positive electrode layer.

In addition to lithium, silicon, boron, and oxygen, one or more additional elements may be added to lithium borosilicate-based glass. For example, the lithium borosilicate-based glass may further contain at least one element selected from the group consisting of elements of Groups 1 and 2 and elements of Groups 14 to 17 of the Periodic Table of the Elements. The respective contents of elements contained in the lithium borosilicate-based glass can be measured by analyzing the glass ceramic-based solid electrolyte using, for example, inductively coupled plasma emission spectroscopy (ICP-AES).

Further, the solid electrolyte may further contain a solid electrolyte used for other known solid-state batteries in addition to the lithium borosilicate glass as a glass-based solid electrolyte. Such a solid electrolyte may be, for example, any one type, or two or more types of a crystalline solid electrolyte, a glass-based solid electrolyte different from the lithium borosilicate glass, a glass ceramic-based solid electrolyte, and the like. Examples of the crystalline solid electrolyte include oxide-based crystal materials. Examples of the oxide-based crystal materials include lithium-containing phosphate compounds that have a NASICON structure, oxides that have a perovskite structure, oxides that have a garnet-type or garnet-type similar structure, and oxide glass ceramic-based lithium ion conductors.

Examples of the lithium-containing phosphate compounds that have a NASICON structure include LixMy(PO4)3 (1≤x≤2, 1≤y≤2, M is at least one selected from the group consisting of titanium (Ti), germanium (Ge), aluminum (Al), gallium (Ga), and zirconium (Zr)). Examples of the lithium-containing phosphate compounds that have a NASICON structure include Li_{1.2}Al_{0.2}Ti_{1.8}(PO₄)₃. An example of the oxides that have a perovskite structure includes La_{0.55}Li_{0.35}TiO₃. An example of the oxides that have a garnet-type or garnet-type similar structure include Li₇La₃Zr₂O₁₂. The crystalline solid electrolyte may include a polymer material (for example, a polyethylene oxide (PEO)).

Examples of the glass-based solid electrolyte include oxide-based glass materials. Examples of the glass-based solid electrolyte excluding lithium borosilicate glass include 30Li₂S-26B₂S₃-44LiI, 63Li₂S-36SiS₂-1Li₃PO₄, 57Li₂S-38SiS₂-5Li₄SiO₄, 70Li₂S-30P₂S₅, and 50Li₂S-50GeS₂.

Examples of the glass ceramic-based solid electrolyte include oxide-based glass ceramic materials. As the oxide-based glass ceramic materials, for example, a phosphate compound (LATP) containing lithium, aluminum, and titanium as constituent elements, and a phosphate compound (LAGP) containing lithium, aluminum, and germanium as constituent elements can be used. LATP is, for example, Li_{1.07}Al_{0.69}Ti_{1.46}(PO₄)₃. LAGP is, for example, Li_{1.5}Al_{0.5}Ge_{1.5}(PO₄).

For example, the solid electrolyte may further contain an oxide having a garnet-type or garnet-type similar structure in addition to the lithium borosilicate glass. For example, the positive electrode layer of the solid-state battery of the present disclosure may contain, as a solid electrolyte, lithium borosilicate glass and an oxide containing Li, La, and Zr (corresponding to a LiLaZr-based oxide). The inventors of the present application have found that when the positive electrode layer contains at least lithium borosilicate glass as a solid electrolyte, the positive electrode active material can preferentially form an interface with lithium borosilicate glass having relatively high thermal stability. Therefore, even when the positive electrode layer contains a solid electrolyte having relatively low thermal stability, the lithium borosilicate glass can suppress the reaction between the positive electrode active material and the solid electrolyte having low thermal stability under a high temperature condition. Therefore, it is possible to further contain another solid electrolyte having excellent lithium ion conductivity although being inferior in thermal stability to lithium borosilicate glass, and it is possible to obtain a solid-state battery more suitably achieving both high-temperature resistance and battery performance (for example, a capacity retention rate or the like).

The content of the lithium borosilicate glass in the solid electrolyte of the positive electrode layer is not particularly limited, and can be, for example, 10 to 90 mass %, 30 to 80 mass %, or 40 to 60 mass % with respect to the total amount of the solid electrolyte in the positive electrode layer. Alternatively, the content of the garnet-type oxide-based solid electrolyte in the solid electrolyte of the positive electrode layer is not particularly limited, but can be, for example, 0 to 70 mass %, 5 to 60 mass %, or 10 to 40 mass % with respect to the total amount of the solid electrolyte in the positive electrode layer. When the content of the garnet-type oxide-based solid electrolyte is within the above ranges, a solid-state battery that can be more suitably used even under a high temperature condition can be provided.

As an example, such an oxide-based solid electrolyte may be a LiLaZr-based oxide (LLZ) having high ionic conductivity. That is, in the present disclosure, two or more kinds of solid electrolytes including a solid electrolyte contributing to thermal stability and a solid electrolyte contributing to high ion conductivity can be used. This makes it possible to maintain battery characteristics under a high temperature condition and to secure ion conductivity that contributes to charging and discharging of the battery.

In the present disclosure, as the positive electrode active material, a material having a layered crystal structure can be used. Specifically, the positive electrode active material may be a layered rock salt-type metal oxide, and may be, for example, a lithium transition metal composite oxide. The “layered rock salt-type metal oxide” refers to a metal oxide having a layered rock salt-type crystal structure that can be identified by analyzing an X-ray diffraction diagram, and particularly refers to particles thereof.

In one example, in the present disclosure, the positive electrode active material contains an oxide containing Li and Co (corresponding to LCO, corresponding to a LiCo-based oxide), and the LiCo-based oxide may contain at least Ti. This makes it possible to increase the thermal weight reduction starting temperature of the positive electrode active material as compared with the case of not containing Ti, and to maintain the battery characteristics under a high temperature condition.

The LiCo-based oxide may further contain at least one element selected from the group consisting of Mg, Al, Ni, Mn, Zr, Zn, Cu, B, P, Si, Ge, Nb, Au, and Pt, in addition to Ti. When the positive electrode active material is a LiCo-based oxide containing at least Ti, the thermal weight reduction starting temperature may be 220° C. or higher and 240° C. or lower.

Specifically, in the present disclosure, the positive electrode active material may contain LiCoxTiyazO2 (wherein x+y+z=1, 0.9≤x<1, 0.005≤y≤0.01, α: at least one element selected from the group consisting of Mg, Al, Ni, Mn, Zr, Zn, Cu, B, P, Si, Ge, Nb, Au, and Pt). Note that, in consideration of suppressing an increase in resistance value and capacity deterioration under a high temperature condition, a is more preferably Al and/or Mg.

In another example, in the present disclosure, the positive electrode active material may contain an oxide containing Li, Ni, Co, and Mn (corresponding to NCM, corresponding to a LiNiCoMn-based oxide). Specifically, the positive electrode active material may be LiNiₐCo_{b}Mn_{c}O₂ (wherein a+b+c≤1, 0.3≤a≤0.8).

In particular, the thermal weight reduction starting temperature when the positive electrode active material is a LiNiCoMn-based oxide may be higher than that when the positive electrode active material is a LiCo-based oxide containing Ti. As a result, when the positive electrode active material is a LiNiCoMn-based oxide, the thermal weight reduction starting temperature of the positive electrode active material can be further increased, and the battery characteristics under a high temperature condition can be more suitably exhibited.

### Method for Producing Solid-State Battery

The solid-state battery of the present disclosure can be manufactured by a printing method such as a screen printing method, a green sheet method using a green sheet, or a method combining these methods. Hereinafter, a case where the printing method and the green sheet method are adopted for understanding the present disclosure will be described in detail, but the present disclosure is not limited to these methods. That is, the solid-state battery may be produced according to a common method for producing a solid-state battery. In addition, the following time-dependent matters such as the order of descriptions are merely considered for convenience of explanation, and the present disclosure is not necessarily bound by the matters.

### (Step of Forming Solid-State Battery Laminate Precursor)

In the present step, for example, several types of pastes such as a positive electrode layer paste, a negative electrode layer paste, a solid electrolyte layer paste, a positive electrode current collector layer paste, a negative electrode current collector layer paste, an electrode separator paste, and an outer layer material paste are used as ink. That is, a solid-state battery laminate precursor having a predetermined structure is formed on a supporting substrate by applying and drying the paste by the printing method.

In printing, a solid-state battery laminate precursor corresponding to a predetermined solid-state battery structure can be formed on a substrate by sequentially laminating printing layers with a predetermined thickness and pattern shape. The type of the pattern forming method is not particularly limited as long as it is a method capable of forming a predetermined pattern, and is, for example, any one or two or more of a screen printing method and a gravure printing method.

The paste can be prepared by wet mixing a predetermined constituent material of each layer appropriately selected from the group consisting of positive electrode active material particles, negative electrode active material particles, a conductive material, a solid electrolyte material, a current collector layer material, an insulating material, a sintering aid, and other materials described above with an organic vehicle in which an organic material is dissolved in a solvent.

The positive electrode layer paste contains, for example, the positive electrode active material particles, the solid electrolyte material, an organic material, a solvent, and optionally a sintering aid.

The negative electrode layer paste contains, for example, the negative electrode active material particles, the solid electrolyte material, an organic material, a solvent, and optionally a sintering aid.

The solid electrolyte layer paste contains, for example, the solid electrolyte material, an organic material, a solvent, and optionally a sintering aid.

The positive electrode current collector layer paste contains a conductive material, an organic material, a solvent, and optionally a sintering aid.

The negative electrode current collector layer paste contains a conductive material, an organic material, a solvent, and optionally a sintering aid.

The electrode separator paste contains, for example, the solid electrolyte material, an insulating material, an organic material, a solvent, and optionally a sintering aid.

The outer layer material paste contains, for example, an insulating material, an organic material, a solvent, and optionally a sintering aid.

The organic material contained in the paste is not particularly limited, but at least one polymer material selected from the group consisting of a polyvinyl acetal resin, a cellulose resin, a polyacrylic resin, a polyurethane resin, a polyvinyl acetate resin, a polyvinyl alcohol resin, and the like can be used.

The type of the solvent is not particularly limited, and the solvent is, for example, one or two or more organic solvents such as butyl acetate, N-methyl-pyrrolidone, toluene, terpineol, and N-methyl-pyrrolidone.

In the wet mixing, a medium can be used, and specifically, a ball mill method, a Visco mill method, or the like can be used. On the other hand, a wet mixing method that does not use a medium may be used, and a sand mill method, a high-pressure homogenizer method, a kneader dispersion method, or the like can be used.

The supporting substrate is not particularly limited as long as the supporting substrate is a support capable of supporting each paste layer, and the supporting substrate is, for example, a release film having one surface subjected to a release treatment, or the like. Specifically, a substrate formed from a polymer material such as polyethylene terephthalate can be used. When the paste layer is used in the firing step while being held on the substrate, the substrate having heat resistance to firing temperature may be used.

Alternatively, each green sheet may be formed from each paste, and the obtained green sheets may be stacked to prepare a solid-state battery laminate precursor.

Specifically, the supporting substrate applied with each paste is dried on a hot plate heated to 30° C. or higher and 90° C. or lower to form, on each supporting substrate (for example, a PET film), a positive electrode layer green sheet, a negative electrode layer green sheet, a solid electrolyte layer green sheet, a positive electrode current collector layer green sheet, a negative electrode current collector layer green sheet, an electrode separator green sheet and/or an outer layer material green sheet or the like having a predetermined shape and thickness.

Next, each green sheet is peeled off from the substrate. After the peeling, the green sheets of the constituent elements are sequentially stacked along the stacking direction to form a solid-state battery laminate precursor. After the stacking, a solid electrolyte layer, an insulating layer and/or a protective layer may be provided in a side region of an electrode green sheet by screen printing.

### (Firing Step)

In the firing step, the solid-state battery laminate precursor is subjected to firing. Although the followings are merely examples, firing is carried out by removing the organic material by heating in a nitrogen gas atmosphere containing oxygen gas or in the atmosphere, for example, at 200° C. or higher, and then heating in the nitrogen gas atmosphere or in the atmosphere, for example, at 300° C. or higher. Firing may be carried out while pressurizing the solid-state battery laminate precursor in the stacking direction (in some cases, stacking direction and direction perpendicular to the stacking direction).

By undergoing such firing, a solid-state battery laminate is formed, so that a desired solid-state battery is finally obtained.

### (Step of Forming Positive Electrode Terminal and Negative Electrode Terminal)

For example, the positive electrode terminal is bonded to the solid-state battery laminate using a conductive adhesive, and the negative electrode terminal is bonded to the solid-state battery laminate using a conductive adhesive. Thereby, each of the positive electrode terminal and the negative electrode terminal is attached to the solid-state battery laminate. As a result, a desired solid-state battery can be finally obtained.

Although the embodiments of the present disclosure have been described above, typical examples have been only illustrated. Therefore, the present disclosure is not limited to those embodiments, and those skilled in the art will readily understand that various aspects can be conceived without changing the gist of the present disclosure.

### EXAMPLES

Hereinafter, Examples will be described.

### Example 1

### (Step of Producing Solid Electrolyte Layer Green Sheet)

First, lithium borosilicate glass as a solid electrolyte and an acrylic binder were mixed at a mass ratio of lithium borosilicate glass:acrylic binder=70:30. As the lithium borosilicate glass, one having a composition of Li₂O:SiO₂:B₂O₃=60:10:30 (mol % ratio) was used. Next, the resulting mixture was mixed with butyl acetate so that the solid content was 30 mass %, and then this mixture was stirred with zirconia balls having a diameter of 5 mm for 4 hours to obtain a solid electrolyte layer paste. Subsequently, the paste was applied onto a release film and dried at 80° C. for 10 minutes to produce a solid electrolyte layer green sheet as a solid electrolyte layer precursor.

### (Step of Producing Positive Electrode Material Layer Green Sheet)

First, a LiNiCoMn-based oxide (corresponding to NCM) was synthesized by a solid phase method in which cobalt oxide, lithium carbonate, nickel, and manganese were mixed and fired. Specifically, in Example 1, LiNi_{0.6}Co_{0.2}Mn_{0.2}O₂ was synthesized. Next, a LiNiCoMn-based oxide (corresponding to NCM) having such a composition as a positive electrode active material and lithium borosilicate glass as a solid electrolyte were mixed at a mass ratio of LiNiCoMn-based oxide:lithium borosilicate glass=75:25. As the lithium borosilicate glass, one having a composition of Li₂O:SiO₂:B₂O₃=60:10:30 (mol % ratio) was used. Next, the resulting mixture and an acrylic binder were mixed at a mass ratio of mixture (LiNiCoMn-based oxide+lithium borosilicate glass):acrylic binder=70:30, and then this was mixed with butyl acetate so that the solid content was 30 mass %. Then, the resulting mixture was stirred with zirconia balls having a diameter of 5 mm for 4 hours to obtain a positive electrode material layer paste. Subsequently, this paste was applied onto a release film and dried at 80° C. for 10 minutes to produce a positive electrode material layer green sheet as a positive electrode material layer precursor.

### (Step of Producing Negative Electrode Material Layer Green Sheet)

First, a carbon powder (KS 6 manufactured by TIMCAL Ltd.) as a negative electrode active material and lithium borosilicate glass as a solid electrolyte were mixed in a mass ratio of carbon powder:lithium borosilicate glass=70:30. As the lithium borosilicate glass, one having a composition of Li₂O:SiO₂:B₂O₃=60:10:30 (mol % ratio) was used. Next, the resulting mixture and an acrylic binder were mixed at a mass ratio of mixture (carbon powder+lithium borosilicate glass):acrylic binder=70:30, and then this was mixed with butyl acetate so that the solid content was 30 mass %. Then, the resulting mixture was stirred with zirconia balls having a diameter of 5 mm for 4 hours to obtain a negative electrode material layer paste. Subsequently, this paste was applied onto a release film and dried at 80° C. for 10 minutes to produce a negative electrode material layer green sheet as a negative electrode material layer precursor.

### (Step of Producing Positive Electrode Current Collector Layer Green Sheet)

First, a carbon powder (KS 6 manufactured by TIMCAL Ltd.) as a conductive material and lithium borosilicate glass as a solid electrolyte were mixed in a mass ratio of carbon powder:lithium borosilicate glass=70:30. As the lithium borosilicate glass, one having a composition of Li₂O:SiO₂:B₂O₃=60:10:30 (mol % ratio) was used. Next, the resulting mixture and an acrylic binder were mixed at a mass ratio of mixture (carbon powder+lithium borosilicate glass):acrylic binder=70:30, and then this was mixed with butyl acetate so that the solid content was 30 mass %. Then, the resulting mixture was stirred with zirconia balls having a diameter of 5 mm for 4 hours to obtain a positive electrode current collector layer paste.

Subsequently, this paste was applied onto a release film and dried at 80° C. for 10 minutes to produce a positive electrode current collector layer green sheet as a positive electrode current collector layer precursor.

### (Step of Producing Negative Electrode Current Collector Layer Green Sheet)

A negative electrode current collector layer green sheet was produced in the same manner as in the step of producing a positive electrode current collector layer green sheet described above.

### (Step of Producing Outer Layer Material Green Sheet)

First, an alumina particle powder (AHP 300manufactured by Nippon Light Metal Company, Ltd.) as a particle powder and lithium borosilicate glass as a solid electrolyte were mixed in a mass ratio of alumina particle powder:lithium borosilicate glass=50:50. Next, the resulting mixture and an acrylic binder were mixed at a mass ratio of mixture (alumina particle powder+lithium borosilicate glass):acrylic binder=70:30, and then this was mixed with butyl acetate so that the solid content was 30mass %. Then, the resulting mixture was stirred with zirconia balls having a diameter of 5 mm for 4 hours to obtain a principal surface outer layer material paste. Subsequently, this paste was applied onto a release film and dried to produce an outer layer material green sheet as an outer layer material precursor.

### (Step of Producing Electrode Separator Green Sheet)

An electrode separator green sheet as an electrode separator precursor was produced in the same manner as in the step of producing an outer layer material green sheet described above.

### (Step of Preparing Laminate)

Using each green sheet obtained as described above, a laminate having the configuration shown in FIGS. 1 and 2 was prepared as follows. Specifically, first, each green sheet was processed into the shape shown in FIGS. 1 and 2, and then released from the release film. Subsequently, the green sheets were sequentially stacked so as to correspond to a configuration of a battery element shown in FIGS. 1 and 2, and then thermocompression-bonded. As a result, a laminate as a battery element precursor was obtained.

### (Step of Sintering Laminate)

The obtained laminate was heated to remove the acrylic binder contained in each green sheet, and then further heated to sinter the oxide glass contained in each green sheet.

### (Step of Producing Terminal)

First, an Ag powder (Daiken Chemical Co., Ltd.) as a conductive particle powder and oxide glass (Bi-B based glass, ASF1096 manufactured by Asahi Glass Co., Ltd.) were mixed at a predetermined mass ratio. Next, the resulting mixture (Ag powder+oxide glass) and an acrylic binder were mixed in a mass ratio of mixture of Ag powder+oxide glass:acrylic binder=70:30, and then this mixture was mixed with a butyl acetate solvent so that the solid content was 50 mass %. Then, the resulting mixture was stirred with zirconia balls having a diameter of 5 mm for 4 hours to obtain a conductive paste. Next, the conductive paste was attached to first and second end surfaces (or side surfaces) of the laminate in which the positive electrode current collector layer and the negative electrode current collector layer were exposed, respectively, and sintered to form positive and negative electrode terminals. As described above, the solid-state battery in Example 1 was obtained.

### Example 2

In Example 2, LiNi_{0.3}Co_{0.3}Mn_{0.3}O₂ was synthesized as a positive electrode active material in the step of producing a positive electrode material layer green sheet in Example 1. Except for this point, a solid-state battery was produced in the same manner as in Example 1.

### Example 3

In Example 3, LiNi_{0.72}Co_{0.05}Mn_{0.2}O₂ having a composition different from those in Examples 1 and 2 was synthesized as a positive electrode active material in the step of producing a positive electrode material layer green sheet in Example 1. Except for this point, a solid-state battery was produced in the same manner as in Example 1.

### Example 4

In Example 4, titanium-containing lithium cobalt oxide (LiCoO₂) was synthesized by a solid phase method in which cobalt oxide, lithium carbonate, and titanium were mixed and fired in the step of producing a positive electrode material layer green sheet in Example 1. Specifically, in Example 4, LiCo_{0.995}Ti_{0.005}O₂ was synthesized as a positive electrode active material. Except for this point, a solid-state battery was produced in the same manner as in Example 1.

### Example 5

In Example 5, LiCo_{0.99}Ti_{0.01}O₂ having a composition different from than in Example 4 was synthesized as a positive electrode active material in the step of producing a positive electrode material layer green sheet in Example 1. Except for this point, a solid-state battery was produced in the same manner as in Example 1.

### Example 6

In Example 6, lithium cobalt oxide (LiCoO₂) containing titanium and aluminum was synthesized by a solid phase method in which cobalt oxide, lithium carbonate, titanium, and aluminum were mixed and fired in the step of producing a positive electrode material layer green sheet in Example 1. Specifically, in Example 6, LiCo_{0.985}Ti_{0.005}Al_{0.01}O₂ was synthesized as a positive electrode active material.

Except for this point, a solid-state battery was produced in the same manner as in Example 1.

### Example 7

In Example 7, LiCo_{0.965}Ti_{0.005}Al_{0.03}O₂ having a composition different from that in Example 6 was synthesized as a positive electrode active material in the step of producing a positive electrode material layer green sheet in Example 1. Except for this point, a solid-state battery was produced in the same manner as in Example 1.

### Example 8

In Example 8, LiCo_{0.945}Ti_{0.005}Al_{0.05}O₂ having a composition different from those in Examples 6 and 7 was synthesized as a positive electrode active material in the step of producing a positive electrode material layer green sheet in Example 1. Except for this point, a solid-state battery was produced in the same manner as in Example 1.

### Example 9

In Example 9, lithium cobalt oxide (LiCoO₂) containing titanium and magnesium was synthesized by a solid phase method in which cobalt oxide, lithium carbonate, titanium, and magnesium were mixed and fired in the step of producing a positive electrode material layer green sheet in Example 1. Specifically, in Example 9, LiCo_{0.985}Ti_{0.005}Mg_{0.01}O₂ was synthesized as a positive electrode active material. Except for this point, a solid-state battery was produced in the same manner as in Example 1.

### Example 10

In Example 10, LiCo_{0.965}Ti_{0.005}Mg_{0.03}O₂ having a composition different from that in Example 9 was synthesized as a positive electrode active material in the step of producing a positive electrode material layer green sheet in Example 1. Except for this point, a solid-state battery was produced in the same manner as in Example 1.

### Example 11

In Example 11, LiCo_{0.945}Ti_{0.005}Mg_{0.05}O₂ having a composition different from those in Examples 9 and 10 was synthesized as a positive electrode active material in the step of producing a positive electrode material layer green sheet in Example 1. Except for this point, a solid-state battery was produced in the same manner as in Example 1.

### Example 12

In Example 12, LiCo_{0.995}Ti_{0.005}O₂ having the same composition as in Example 4 was synthesized as a positive electrode active material in the step of producing a positive electrode material layer green sheet in Example 1. On the other hand, as the solid electrolyte used in the step of producing each green sheet in Example 1, not only lithium borosilicate glass but also a mixture of lithium borosilicate glass and a LiLaZr-based oxide (mass ratio of Li₇La₃Zr₂O₁₂ (LLZ)) (lithium borosilicate glass:LLZ=60:40). Except for these points, a solid-state battery was produced in the same manner as in Example 1.

### Comparative Example 1

A solid-state battery was produced in the same manner as in Example 1, except that lithium cobalt oxide not containing titanium was used as a positive electrode active material.

### Comparative Example 2

A solid-state battery was produced in the same manner as in Example 4, except that a LiLaZr-based oxide was used as a solid electrolyte. As the LiLaZr-based oxide, Li₇La₃Zr₂O₁₂ was used.

### Comparative Example 3

A solid-state battery was produced in the same manner as in Example 1, except that an oxide containing Li, Mn, and Al (corresponding to a LiMnAl-based oxide) was used as a solid electrolyte. As the LiMnAl-based oxide, LiMn_{1.92}Al_{0.08}O₄ (LMO) was used.

### (Measurement of Battery Characteristics)

A rated capacity of the battery was set to 1 C, the battery was charged to a predetermined positive electrode potential at a constant current of 0.2 C, after reaching the positive electrode potential, the battery was charged in a constant voltage mode until the current was contracted to 0.01 C, and impedance measurement was performed to determine an initial resistance value. Thereafter, the battery was stored at a high temperature condition (105° C.) for 1 week, slowly cooled to 25° C. by air cooling, then subjected to impedance measurement at 25° C., discharged to 2 V at a constant current of 0.2 C, and subjected to capacity measurement. Note that, as the positive electrode potential, different potentials were used according to the positive electrode active material. Specifically, charging was performed up to a positive electrode potential of 4.35 V when the positive electrode active material is a LiCo-based oxide (LCO), 4.2 V when the positive electrode active material is a LiNiCoMn-based oxide (NCM), or 4.95 V when the positive electrode active material is a LiMnAl-based oxide (LMO).

For the solid-state batteries of Examples 1 to 12 and Comparative Examples 1 and 2, each resistance increase rate was calculated by dividing the initial resistance value obtained from the result of impedance measurement by the resistance value after storage under a high temperature condition. Similarly, from the results of capacity measurement, the deterioration capacity of the discharge capacity after storage under a high temperature condition was determined. Further, the capacity retention rates of the solid-state batteries of Examples 1, 2, and 4 to 12 and

Comparative Examples 1 to 3 were measured. Specifically, a rated capacity of the battery was set to 1 C, the battery was charged to the above-described positive electrode potential at a constant current of 0.2 C, and after reaching the positive electrode potential, the battery was charged in a constant voltage mode until the current was contracted to 0.01 C. Thereafter, discharge was performed at a constant current of 0.2 C until the positive electrode potential reaches 3 V. A capacity retention rate with respect to an initial discharge capacity when 100 cycles were repeated with such charge and discharge as 1 cycle was measured.

In each of Examples 1 to 12 and Comparative Examples 1 to 3, a thermogravimetric/differential thermal analyzer (TG-DTA) (manufactured by Rigaku Corporation, device model number: TG8120) was used, the positive electrode layer was set in the device, heating was performed at a temperature increase rate of 3° C./min while nitrogen flow was performed at a rate of 200 ml/min to measure a thermal weight reduction starting temperature of the positive electrode active material at which the weight of the positive electrode active material contained in the positive electrode layer at the start of measurement decreased by 0.67% or more. Specifically, as the temperature is increased, the weight of the positive electrode active material changes from a predetermined temperature value. When this weight change occurs, the main beam in the device is tilted, and the current flowing through the coil is controlled so as to restore the movement. Since the flowed current corresponds to a weight change, a variation behavior of the current was output as a weight change, thereby grasping the thermal weight reduction starting temperature of the positive electrode active material.

Note that the weight of the positive electrode active material at the start of the measurement can be calculated from the weight of the positive electrode layer and the mixing ratio of the positive electrode active material in the positive electrode layer.

These measurement results are shown in Table 1. Note that, the resistance increase rate and the deterioration capacity are shown as the relative resistance increase rate and the relative deterioration capacity of Examples 1 to 12 and Comparative Examples 1 and 2 when the resistance increase rate and the deterioration capacity in Comparative Example 1 are “100”.

TABLE 1

| | | | Thermal weight | All-solid-state battery | | |
|---|---|---|---|---|---|---|
| | | | reduction starting | performance | | |
| | | | temperature (° C.) | Relative | | |
| | Composition of | | (state where lithium | resistance | Relative | Capacity |
| | positive electrode | Solid | desorption amount is | increase | deterioration | retention |
| | active material | electrolyte | 40%) | rate (%) | capacity (%) | rate (%) |
| Example 1 | LiNi_{0.6}Co_{0.2}Mn_{0.2}O₂ | Li—Si—B-0 glass | 305 | 46 | 21 | 48 |
| Example 2 | LiNi_{0.3}Co_{0.3}Mn_{0.3}O₂ | Li—Si—B-0 glass | 280 | 50 | 28 | 46 |
| Example 3 | LiNi_{0.72}Co_{0.05}Mn_{0.2}O₂ | Li—Si—B-0 glass | 257 | 42 | 26 | — |
| Example 4 | LiCo_{0.995}Ti_{0.005}O₂ | Li—Si—B-0 glass | 221 | 33 | 85 | 62 |
| Example 5 | LiCo_{0.99}Ti_{0.01}O₂ | Li—Si—B-0 glass | 230 | 31 | 86 | 64 |
| Example 6 | LiCo_{0.985}Ti_{0.005}Al_{0.01}O₂ | Li—Si—B-0 glass | 231 | 21 | 73 | 65 |
| Example 7 | LiCo_{0.965}Ti_{0.005}Al_{0.03}O₂ | Li—Si—B-0 glass | 234 | 12 | 60 | 67 |
| Example 8 | LiCo_{0.945}Ti_{0.005}Al_{0.05}O₂ | Li—Si—B-0 glass | 239 | 13 | 59 | 67 |
| Example 9 | LiCo_{0.985}Ti_{0.005}Mg_{0.01}O₂ | Li—Si—B-0 glass | 230 | 20 | 70 | 62 |
| Example 10 | LiCo_{0.965}Ti_{0.005}Mg_{0.03}O₂ | Li—Si—B-0 glass | 231 | 10 | 76 | 61 |
| Example 11 | LiCo_{0.945}Ti_{0.005}Mg_{0.05}O₂ | Li—Si—B-0 glass | 231 | 6 | 91 | 59 |
| Example 12 | LiCo_{0.995}Ti_{0.005}O₂ | Li—Si—B-0 glass + | 220 | 40 | 90 | 71 |
| | | LiLaZr-based | | | | |
| | | oxide | | | | |
| Comparative | LiCoO₂ | Li—Si—B-0 glass | 203 | 100 | 100 | 50 |
| Example 1 | | | | | | |
| Comparative | LiCo_{0.995}Ti_{0.005}O₂ | LiLaZr-based | 210 | 66 | 115 | 75 |
| Example 2 | | oxide | | | | |
| Comparative | LiMn_{1.92}Al_{0.08}O₄ | Li—Si—B-0 glass | 485 | — | — | — |
| Example 3 | | | | | | |

From the above measurement results, it was found that in Examples 1 to 12, in a case in which the solid electrolyte in the positive electrode layer contains lithium borosilicate glass in a state where the lithium desorption amount of the positive electrode active material of the obtained solid-state battery is 40%, when the thermal weight reduction starting temperature at which the weight of the positive electrode active material decrease by 0.67% or more is 220° C. or higher, both the relative resistance increase rate and the relative deterioration capacity of the solid-state battery are lower than the values in the case of Comparative Example 1 (thermal weight reduction starting temperature: 203° C. +solid electrolyte in the positive electrode layer: lithium borosilicate glass-containing).

In Comparative Example 2 (thermal weight reduction starting temperature: 210° C.+solid electrolyte in the positive electrode layer: LiLaZr-based oxide-containing/lithium borosilicate glass-free), it was found that the relative deterioration capacity of the solid-state battery is lower than that in Comparative Example 1.

In Comparative Example 3 (thermal weight reduction starting temperature: 485° C.+solid electrolyte in the positive electrode layer: lithium borosilicate glass), it was found that, from the fact that the capacity retention rate was 0%, as compared with Examples 1 to 12, the capacity was not maintained with respect to the initial discharge capacity when charging and discharging of the battery were repeated 100 cycles.

From the above, as a whole, in the case of a positive electrode layer using a solid electrolyte containing lithium borosilicate glass and a positive electrode active material having a thermal weight reduction starting temperature of 220° C. or higher and lower than 485° C., it has been found that suitable battery characteristics (such as a relative resistance increase rate) even under a high temperature condition can be achieved. That is, it was found that the solid-state battery in this example can have suitable high-temperature resistance.

The solid-state battery of the present disclosure can be used in various fields in which electricity storage is assumed. Although the followings are merely examples, the solid-state battery of the present disclosure can be used in electricity, information and communication fields where mobile equipment and the like are used (e.g., electrical/electronic equipment fields or mobile device fields including mobile phones, smart phones, laptop computers, digital cameras, activity meters, arm computers, electronic papers, and small electronic devices such as RFID tags, card type electronic money, and smartwatches), domestic and small industrial applications (e.g., the fields such as electric tools, golf carts, domestic robots, caregiving robots, and industrial robots), large industrial applications (e.g., the fields such as forklifts, elevators, and harbor cranes), transportation system fields (e.g., the fields such as hybrid vehicles, electric vehicles, buses, trains, electric assisted bicycles, and two-wheeled electric vehicles), electric power system applications (e.g., the fields such as various power generation systems, load conditioners, smart grids, and home-installation type power storage systems), medical applications (medical equipment fields such as earphone hearing aids), pharmaceutical applications (the fields such as dose management systems), IoT fields, and space and deep sea applications (e.g., the fields such as spacecraft and research submarines).

### DESCRIPTION OF REFERENCE SYMBOLS

10: Electrode layer
10A: Positive electrode layer
10B: Negative electrode layer
11: Electrode current collector layer
11A: Positive electrode current collector layer
11B: Negative electrode current collector layer
20: Solid electrolyte layer
30: Electrode separator
30A: Positive electrode separator
30B: Negative electrode separator
40: Terminal
40A: Positive electrode terminal
40B: Negative electrode terminal
60: Outer layer material
100: Solid-state battery laminate
200: Solid-state battery

1. A solid-state battery comprising:
a positive electrode layer containing a positive electrode active material containing Li and a solid electrolyte, wherein
a thermal weight reduction starting temperature at which a weight of the positive electrode active material decreases by 0.67% or more is 220° C. or higher and lower than 485° C. in a state where a lithium desorption amount of the positive electrode active material is 40%, and the solid electrolyte contains lithium borosilicate glass.

2. The solid-state battery according to claim 1, wherein the positive electrode active material has a layered rock salt-type crystal structure.

3. The solid-state battery according to claim 1, wherein the thermal weight reduction starting temperature is 220° C. to 350° C.

4. The solid-state battery according to claim 1, wherein a content of the lithium borosilicate glass in the solid electrolyte of the positive electrode layer is 10 to 90 mass % with respect to a total amount of the solid electrolyte in the positive electrode layer.

5. The solid-state battery according to claim 1, wherein the positive electrode active material contains an oxide containing Li, Co, and Ti.

6. The solid-state battery according to claim 5, wherein the thermal weight reduction starting temperature is 220° C. or higher and 240° C. or lower.

7. The solid-state battery according to claim 5, wherein the positive electrode active material further contains Mg and/or Al.

8. The solid-state battery according to claim 5, wherein the oxide further contains at least one element selected from Mg, Al, Ni, Mn, Zr, Zn, Cu, B, P, Si, Ge, Nb, Au, and Pt.

9. The solid-state battery according to claim 5, wherein the oxide is represented by LiCoₓTi_{y}α_{z}O₂, wherein x+y+z=1, 0.9≤x<1, 0.005≤y≤0.01, and a is Mg and/or Al.

10. The solid-state battery according to claim 1, wherein the positive electrode active material contains an oxide containing Li, Ni, Co, and Mn.

11. The solid-state battery according to claim 10, wherein the oxide is represented by LiNiₐCo_{b}Mn_{c}O₂, wherein a+b+c≤1, 0.3≤a≤0.8.

12. The solid-state battery according to claim 1, wherein the thermal weight reduction starting temperature when the positive electrode active material is an oxide containing Li, Ni, Co, and Mn is higher than that when the positive electrode active material is a Ti-containing oxide containing Li and Co.

13. The solid-state battery according to claim 1, wherein the solid electrolyte further contains an oxide-based solid electrolyte having a garnet-type crystal structure.

14. The solid-state battery according to claim 13, wherein the oxide-based solid electrolyte is an oxide containing Li, La, and Zr.

15. The solid-state battery according to claim 13, wherein a content of the lithium borosilicate glass in the solid electrolyte of the positive electrode layer is 10 to 90 mass % with respect to a total amount of the solid electrolyte in the positive electrode layer, and a content of the oxide-based solid electrolyte having the garnet-type crystal structure is up to 70 mass with respect to the total amount of the solid electrolyte in the positive electrode layer.
